(19) United States
(12) Patent Application Publication
(10) Pub. No.: US 2023/0080669 A1
(43) Pub. Date: Mar. 16, 2023

(54) LENGTH-ADJUSTABLE CONNECTING ROD PROVIDED WITH A RESISTIVE TORQUE DEVICE

(71) Applicant: EPSILON COMPOSITE, Gaillan en Médoc (FR)

(72) Inventors: Yann CHAUMET, Gaillan en Médoc (FR); José PORTOLES, Queyrac (FR); Valentin ALBISTUR, Saint-Julien Beychevelle (FR)

(21) Appl. No.: 17/796,243

(22) PCT Filed: Feb. 14, 2020
(86) PCT No.: PCT/FR2020/000032

§ 371 Date: Jul. 28, 2022

(51) Int. Cl. F16C 7/06

(52) U.S. Cl. CPC F16C 7/06

(57) ABSTRACT

A length-adjustable connecting rod is disclosed having a longitudinal axis comprising a connecting-rod shank provided with at least one internal thread, at least one connecting element comprising an external thread cooperating with the internal thread of the connecting-rod shank, the screwing or unscrewing of the connecting-rod shank with respect to the connecting element allowing the length of the connecting rod to be adjusted, and at least one resisting torque device between the connecting-rod shank and the connecting element, the resisting torque device comprising at least one pressing element and a bearing element, the pressing element exerting a force on the bearing element that opposes a resistance to the rotational movement of the connecting-rod shank with respect to said connecting element. The bearing element is integral with the connecting element and the pressing element is integral with the connecting-rod shank.

The present invention relates to the technical field of connecting rods, shafts and arms intended to be positioned between two fixed or mobile members, the length of which can be adjusted in order to fit, and relates in particular to a length-adjustable connecting rod provided with a resisting torque device.

### STATE OF THE ART

Such rods are used, for example, between a fixed and a mobile member such as a shutter mechanism. Due to manufacturing and assembly tolerances of the individual components, the distance between them can fluctuate by several millimeters. In order to fit the connecting rod, it is necessary to adjust its length. This is achieved by means of length-adjustable connecting rods comprising a connecting element such as a fork, a ball joint or a metal clevis and a tube that cooperates with a threaded device to change the length of the connecting rod when it is fitted. The length-adjustable connecting rod may also comprise a rotational braking device that acts on the rotational movement to apply a specific locking force between the fork and the tube and thus prevent an unintentional change in length of the connecting rod when it is not stressed to deliberately vary its length, as in the case of stresses due to vibrations, fatigue cycle in traction, compression, bending, thermal gradient up to 140° C.

For example, WO2006042750 describes a tension-compression bar that comprises a fork and a tube, the rotation of the fork around the tube can be locked by a locking device that comprises a partial ring with a locking nose and a ring gear.

The disadvantage of such a device is that it requires an intermediate part such as a sleeve placed between the fork and the tube and comprising two threads, a first thread located on the external wall of the sleeve for connecting the tube of the connecting rod and a second thread located on the internal wall for connecting the fork. When mounting the connecting rod, the first thread must be kept locked because only the second thread is involved in adjusting the length of the connecting rod. This double thread makes the manufacture and assembly of the parts that make up the connecting rod more complex. In addition, if the locking of the first thread is to be secured, an additional step must be performed, such as gluing the thread.

On the other hand, the connecting rod locking device described in WO2006042750 acts on the torque between the fork and the tube by virtue of the locking nose of the partial ring that fits into a space in the ring gear. The partial ring is connected to the fork by means of an offset bolt and a connecting element that links the partial ring to the bolt. These two fasteners are prominent with respect to the outer circumference of the connecting rod. Also the ends of the partial ring are directed outwardly and are prominent. The positioning of these elements can injure the operator who handles and sets up the connecting rod.

In addition, the fact that the partial ring is fixed to the connecting rod by means of a fastener offset from the plane in which the clamping force is exerted creates a clamping torque between the fork and the tube that varies according to the position of the fork in the tube. In addition, the locking nose of the partial ring is not aligned, in the direction of the axis of rotation, with the connecting element, which means that the tightening torque is not identical depending on whether the operator turns the connecting rod in one direction or the other. Therefore, the torque between the fork and the tube also varies depending on the direction of adjustment of the fork with respect to the tube.

Similarly, the connecting rod described in WO2011057627 comprises two threads, one of which allows the length of the connecting rod to be changed. This thread comprises a first thread located on the outside of the fork that cooperates with a second thread located on the inside of a connecting piece. A spring presses two locking elements together in the longitudinal direction of the connecting rod. As the spring is supported with its ends between the fork and the connecting piece, it also presses the external thread against the internal thread of the connecting rod, which allows the length of the connecting rod to be changed. One of the disadvantages of this connecting rod is that the torque depends on the friction between the locking elements but also on the friction between the two threads. Now the friction between the two threads depends on the surface in contact with the threads, this surface is lowest when the fork is completely extended and greatest when it is completely retracted. As a result, the torque between the fork and the tube varies depending on the position of the fork in the tube.

### DESCRIPTION OF THE INVENTION

Therefore, the purpose of the invention is to provide a length-adjustable connecting rod with a resisting torque device that overcomes the above-mentioned disadvantages and, in particular, that comprises a single thread per end and provides a constant resisting torque, regardless of the position of the fork in relation to the tube.

Another purpose of the invention is to provide a simple and economical manufacturing method for making length-adjustable connecting rods whose resisting torque device provides a constant resisting torque regardless of the position of the fork relative to the tube.

The object of the invention is therefore a length-adjustable connecting rod having a longitudinal axis, comprising a connecting-rod shank provided with at least one internal thread, at least one connecting element comprising an external thread cooperating with the internal thread of the connecting-rod shank, the screwing or unscrewing of the connecting-rod shank with respect to the connecting element allowing the length of the connecting rod to be adjusted, and at least one resisting torque device between the connecting-rod shank and the connecting element, the resisting torque device comprising at least one pressing element and a bearing element, the pressing element exerting a force on the bearing element that opposes a resistance to the rotational movement of the connecting-rod shank with respect to the said connecting element. The connecting rod is characterized in that the bearing element is integral with the connecting element and the pressing element is integral with the connecting-rod shank and in that the force exerted by the pressing element on the bearing element is in a transverse direction and perpendicular to the longitudinal axis of the connecting rod.

Another object of the invention is a method for making and assembling a connecting rod, comprising the following steps:

a) a connecting-rod shank consisting of an end cap, a threaded insert and a tube is manufactured and assembled in a single injection-molding step,
b) a connecting element is machined in one piece, preferably from a metallic material, with a first free end and a second end having a locking device,
c) a notched ring is securely mounted on the connecting element,
d) a gasket is placed in a groove provided on the connecting element at the end of the notched ring,
e) at least one ball plunger or leaf spring is placed in a receptacle provided for this purpose in the wall thickness of the end cap,
f) the connecting element is inserted and screwed into the connecting-rod shank by cooperation of the threads and until the two blades at the opposite end of the free end of the connecting element come to rest with their locking element in the form of a radially outwardly projecting bead against the end of the threaded insert, the locking device thereby being automatically inserted.

### BRIEF DESCRIPTION OF THE FIGURES

The purposes, objects and features of the invention will become clearer upon reading the following description made with reference to the drawings wherein:

FIG. 1 shows the connecting rod according to the invention with two fork-like connecting elements,

FIG. 2 shows a side view of the fork at one end of the connecting rod,

FIG. 3 shows a side view of the fork fitted to one end of the connecting rod at 90° to the view in FIG. 2,

FIG. 4 shows an exploded view of one end of the connecting-rod shank according to a first embodiment,

FIG. 5 shows a cross-section of the connecting rod according to the first embodiment,

FIG. 6a shows a longitudinal section of one end of the connecting rod at a setting corresponding to an intermediate length according to the first embodiment,

FIG. 6b shows a longitudinal section of one end of the connecting rod at a setting corresponding to the maximum length in the first embodiment,

FIG. 6c shows a longitudinal section of one end of the connecting rod at a setting corresponding to a minimum length according to the first embodiment,

FIG. 7 shows an exploded view of one end of the connecting-rod shank according to a second embodiment,

FIG. 8 shows a cross-section of the connecting rod according to the second embodiment,

FIG. 9 shows a longitudinal section of one end of the connecting rod at a setting corresponding to an intermediate length according to the second embodiment.

### DETAILED DESCRIPTION OF THE INVENTION

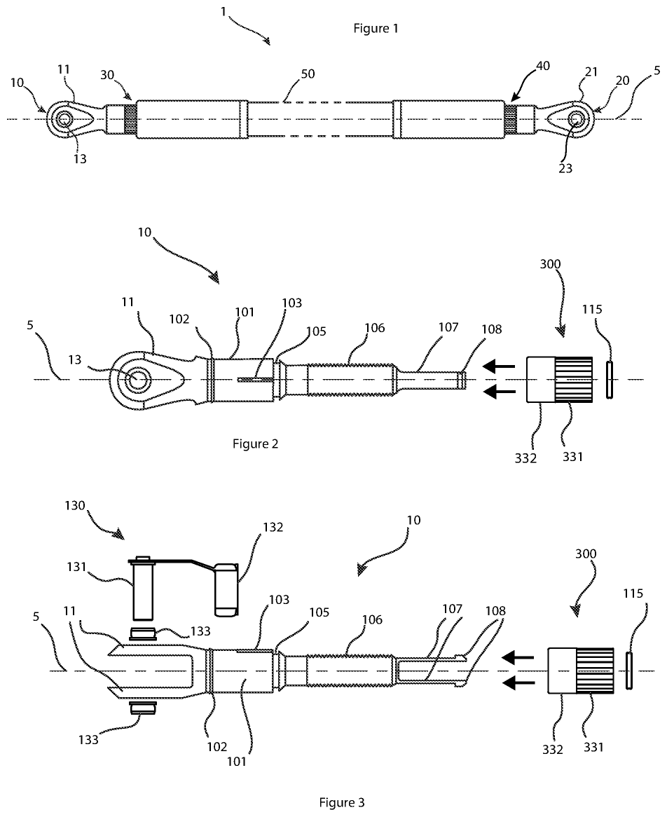

FIG. 1 shows a connecting rod according to the invention. The connecting rod 1 has a rectilinear shape and comprises an elongated and hollow body 50, the center of which is shown in dotted lines in the figure. The connecting rod is fitted on at least one of its ends with a connecting element 10 comprising, on its free end, connecting means 11 and 13 that serve to connect the connecting rod on its location. According to FIG. 1, the connecting rod 1 comprises a second connecting element 20 identical to the first connecting element 10 and two opposing threads. The connecting element 20 comprises connecting means 21 and 23 on its free end. In the preferred embodiment of the invention, the connecting element 10 and 20 is a fork. However, it could be a clevis or a ball joint without going outside the scope of the invention. The fork 10 comprises two ends 11 each with an opening 13 and the fork 20 comprises two ends 21 each with an opening 23. The connecting rod 1 is equipped with at least one identical resisting torque device 30 and/or 40 between each fork and the connecting-rod shank. Each resisting torque device has a pressing element and a bearing element. The pressing element is made in various embodiments described later in the description.

FIG. 2 illustrates a whole fork 10 or 20 as well as the part of the resisting torque device integral with the fork that corresponds to the bearing element of the resisting torque device. The fork 10 or 20 has a central longitudinal axis represented by axis 5. In FIG. 3, the fork 10 or 20 and the bearing element are rotated by 90° around the axis 5 with respect to FIG. 2. In FIGS. 2 and 3, the bearing element of the resisting torque device integral with the fork is shown as part of a separate element 300 of the fork, added during the assembly of the connecting rod, however it could be machined directly on the metal fork, for example one made of aluminum, without going beyond the scope of the invention.

The embodiment described and illustrated in the figures is therefore the preferred embodiment when the bearing device and the fork are not made of the same material, for example for an aluminum fork and a thermoplastic bearing element. This method reduces the risk of galvanic corrosion. In this embodiment, the bearing element is integrally mounted on the connecting element by virtue of means for immobilizing it on the connecting element. These means are described in the following description.

The free end of the fork 10 extends into a central cylindrical portion 101 that supports the bearing element of the resisting torque device.

The central cylindrical portion 101 is provided with a flange 102 located on the outer face of the cylindrical portion 101 on the side of the free end of the fork.

The flange is circular and located in a plane perpendicular to the axis 5 and its external diameter is greater than the external diameter of the cylindrical part by 0.1 mm to 0.5 mm. The flange has two opposite faces, a flat face perpendicular to the axis 5 and a truncated cone-shaped face. The flat face is located on the side of the free end of the fork while the truncated cone-shaped face is directed in the opposite direction, i.e. towards the center of the connecting rod.

At the opposite end of the free end of the fork, the cylindrical part is extended by a groove 105 adapted to house a gasket 115, a thread 106 and two blades 107 each provided on their external face and at their end with a locking element in the form of a bead 108 projecting radially outwardly. The central cylindrical portion 101 comprises at least one slot 103 located on its outer surface and parallel to the axis 5 extending from the groove 105 toward the middle portion of the cylindrical portion. According to another embodiment, the central cylindrical portion 101 comprises a second slot also located on its outer surface, parallel and preferably diametrically opposite to the first slot. The gasket 115 guarantees the seal between the tube and the fork against galvanic corrosion.

The bearing element of the resistant torque device and integral with the fork is a toothing 331 comprising a set of teeth. Even in the case where the bearing element is machined directly with the fork, the toothing 331 is preferably straight, i.e., the teeth of the toothing 331 are evenly distributed circumferentially and parallel to the longitudinal axis 5. According to the embodiment shown in FIGS. 2 and 3, the toothing 331 is part of a notched ring 300. The notched ring has a cylindrical shape and has on its outer surface a smooth portion 332 and the toothing 331.

The fork 10 and 20 and the notched ring 300 comprise means for securing the notched ring to the fork. The interior of the ring 300 is not shown in the figures and comprises an annular groove formed at the edge of the cylindrical inner face of the ring on the side of its smooth portion. The inner diameter of the notched ring is equal to or slightly larger than the outer diameter of the cylindrical part 101 of the fork on which it is positioned. The notched ring is fitted onto the fork by its second end located on the opposite side of its free end as far as the flange 102 so that its inner face rests on the outer face of the cylindrical part 101 of the fork. The complementary shape of the flange 102 and the annular groove of the ring allows the notched ring to slide over the flange with sufficient force to fit into the groove, the groove of the notched ring and the flange 102 thus cooperating together. The flat, perpendicular face of the flange prevents the ring from sliding out of place in the opposite direction. In the case where the bearing element is machined directly with the fork, the toothing 331 is located on the outer face of the cylindrical portion 101.

The notched ring 300 further comprises at least one straight boss formed on its inner side. This straight boss extends from the edge of the ring on the side of the smooth part to its middle part and is parallel to the longitudinal axis 5. The shape of this boss is complementary to the slot 103 of the cylindrical part 101 so that the boss of the notched ring 300 and the slot 103 cooperate with each other when the ring is slipped onto the fork 10 or 20. In another embodiment, the ring comprises a second diametrically opposed boss on its inner surface so that each boss cooperates with each of the two slots in the fork.

The cooperation of the flange 102 with the ring groove as well as the gasket 115 ensure that the ring 300 is held immobile relative to the fork against translational movement in both directions of the longitudinal axis 5. Similarly, the cooperation of the slot 103 with the boss of the ring prevents any rotational movement of the ring around the longitudinal axis 5. Thus, once the notched ring 300 is placed on the fork, it is secured in relation to it.

The connecting rod 1 comprises at least one fastener adapted to connect the two ends 11 of the fork 10 in a direction transverse to the longitudinal axis of the connecting rod. The fastener is a snap-in clip 130 comprising a pin 131 passing through the two openings 13 or the two openings 23 of the ends 11 or the ends 21 of the fork 10 or 20 via two rings 133. The pin 131 is connected to a clip 132 that snaps elastically around the central cylindrical part 101 of the fork, on the smooth part 332 of the notched ring or directly on the fork in the case where the bearing element is machined directly on the fork. Once in place, the snap-in clip 130 allows the connecting rod to be coupled and locked to an external member without preventing its length from being adjusted.

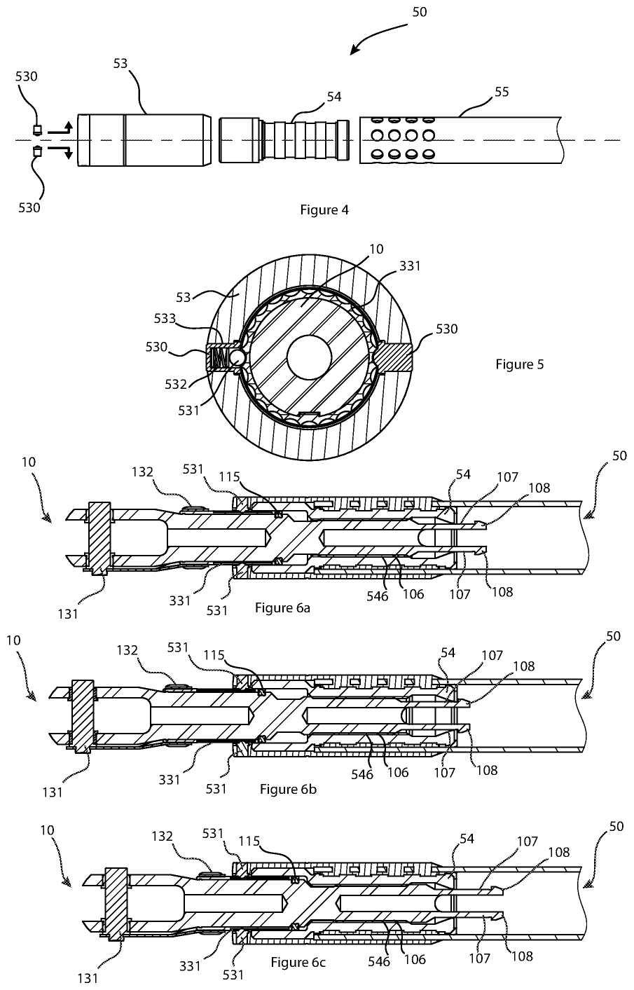

FIG. 4 shows one of the two ends of the connecting-rod shank 50 in exploded view. It consists of a cylindrical end cap 53, a cylindrical threaded insert 54 and a tube 55. The threaded insert is assembled and attached to the tube by means of the end cap made partly around the threaded insert, between the threaded insert and the tube and around the tube by a process of thermoplastic injection or thermoplastic over-injection onto a metal part as described in patent application EP 3 302 916.

The advantage of this assembly is that it can be made in a few steps and can withstand high traction, compression and temperature gradients and with materials of different expansion coefficients. In fact, the end cap is made of thermoplastic or thermoplastic composite and the tube is made of a thermoplastic or thermosetting composite, e.g., thermosetting carbon. The threaded insert can be made of a polymer such as a thermoplastic, but also of a metal material or a combination of both. The metal material can be aluminum or titanium or an alloy of both. The fork is made of a hollow tubular structure at both ends for weight reasons.

The pressing element of the resisting torque device 30, which is integral with the connecting-rod shank 50, is intended to cooperate with the bearing element of the resisting torque device and thus with the toothing 331. According to a first embodiment of the invention, the pressing element of the resisting torque device 30 comprises at least one ball plunger 530 and the means for securing the pressing element is a receptacle 533 for each ball plunger 530, each receptacle 533 being provided in the wall thickness of the connecting-rod shank and more precisely in the wall thickness of the end cap 53 on the side opposite the tube 55.

FIG. 5 shows a cross-section of the connecting rod perpendicular to the axis 5 comprising two ball plungers 530 according to a preferred embodiment. The ball plungers are ball- and spring-loaded. A spring 532 compresses a ball 531 mounted loosely in the ball plunger and having a portion of its surface flush with the outside of the plunger. The ball plunger has a flange on its outer face on the ball side that abuts a shoulder of the receptacle 533 when inserted therein through an opening on the inner face of the end cap wall 53. The shape of the receptacle 533 of the ball plunger 530 is adapted to immobilize the plunger against translational movement in both directions of the longitudinal axis 5 of the connecting rod. The receptacle 533 is therefore preferably cylindrical with a diameter equal to or slightly larger than the diameter of the portion of the ball plunger without the flange.

When the fork 10 and connecting-rod shank 50 are assembled together, the flush surface of the ball 531 of each ball plunger 530 is in permanent contact with the toothing 331 of the resisting torque device. The ball plungers can no longer be removed from their seats because they are jammed between the end cap 53 and the toothing 331.

The flush surface of each ball cooperates with a recess in the toothing 331. Preferably, the size of the balls is adapted to cooperate with a recess in the toothing 331 and the shape of the recesses in the toothing 331 is complementary to the shape of the balls. The ball plungers are integral with the end cap 53 and thus with the connecting-rod shank. The rotation of the connecting-rod shank drives the ball plungers 530 in rotation. The spring of each ball plunger exerts a force on the ball and thus on the toothing 331 that increases as the ball moves from a gap between two teeth to the adjacent gap. This effort opposes a resistance to the rotational movement of the connecting-rod shank in relation to the fork by friction of the ball against the toothing, which means that the operator must exert a necessary and sufficient torque effort to rotate the connecting-rod shank in relation to the fork. This necessary and sufficient torque must be greater than the resisting torque of each ball 533 on the toothing 331.

Each ball plunger provides an independent and equal point spring effect on the toothing, exerted by the spring pushing on the ball and acting only in the direction of the plunger axis to push the ball into a recess in the toothing. The force exerted by each ball on the toothing 331 is then identical and predictable, which has the advantage of being able to size the desired force by increasing or decreasing the number of ball plungers. The number of plungers can be between 1 and 8.

FIGS. 6a, 6b and 6c, illustrate a longitudinal section of one end of the connecting rod fitted with the fork 10 according to three positions of the fork 10 with respect to the connecting-rod shank 50. The fork is inserted into the connecting-rod shank through the end cap 53 until the external thread 106 of the fork mates with a thread 546 on the inside of the insert 54. The fork is then screwed in until the end 108 of the blades 107 projecting radially from the fork 10 pass the end of the insert 54, the blades 107 provided with the bead 108 at their ends then serve as a means of locking the fork in the connecting-rod shank by preventing it from being withdrawn when the fork is unscrewed. Indeed, as can be seen in FIG. 6b, the maximum size of the connecting rod is reached when the shoulder of the bead 108 of the end of the blades 107 is in abutment with the end of the insert 54.

The length of the connecting rod can be adjusted by screwing or unscrewing the connecting-rod shank in relation to the fork. In the case of a connecting rod with a fork at each end, the connecting-rod shank 50 has two threaded inserts 54 each with a thread 546 and two end caps 53. The threading device of the second fork is oriented in the opposite direction to the threading device of the first fork so that rotation of the connecting-rod shank in one direction causes both forks to extend and rotation of the connecting-rod shank in the opposite direction causes both forks to enter the connecting-rod shank. FIG. 6c shows the position of the connecting rod when the fork 10 is fully retracted and FIG. 6a shows an intermediate position of the fork. Therefore, the fork can be rotatably moved in the connecting-rod shank 50 between two positions without being removable from the connecting-rod shank due to the locking means 107 and 108 provided to lock the fork in the connecting-rod shank and that are automatically active during the assembly of the connecting rod.

According to a second embodiment of the invention illustrated in FIGS. 7, 8 and 9, the pressing element of the resistant torque device integral with the connecting-rod shank comprises at least one leaf spring 730 and the end cap 53 comprises at least one means for securing the pressing element. In the case of leaf spring 730, the means for securing is at least one receptacle 733 per leaf spring 730, each receptacle 733 being provided within the end cap 53 on the side opposite the tube 55.

The leaf spring 730 is seen in detail in FIG. 7, which represents a cross-section of the connecting rod perpendicular to the axis 5. The leaf spring 730 partially surrounds the toothing 331. At least one of the two ends of the leaf spring 730 is inserted into a receptacle 733 in the form of a notch provided on the inner surface in the thickness of the walls of the connecting-rod shank and more specifically in the thickness of the walls of the end cap 53. The shape of the receptacle of at least one end of the leaf spring is adapted to immobilize the leaf spring against any translational movement in both directions of the longitudinal axis 5. The positioning of the leaf spring in its receptacle in the end cap 53 makes the blade integral with the end cap 53 and therefore integral with the connecting-rod shank 50.

On the other hand, once the fork is inserted into the connecting-rod shank, the leaf spring cannot be removed from its location because it is wedged between the end cap 53 and the toothing 331 of the resisting torque device. The blade 730 is clamped but not completely immobilized so that there is a gap between the end cap 53 and the toothing 331 for the leaf spring to exert its resilience. The blade 730 has at least one tooth 731 shaped to cooperate with a recess in the toothing 331. When the fork is assembled on the connecting-rod shank 50, the tooth 731 is in permanent contact with the toothing 331 of the resisting torque device.

Preferably, the device according to the invention comprises more than one leaf spring, each leaf spring has a single tooth 731 and all leaf springs are identical. The leaf springs are then positioned side-by-side in the end cap so that the teeth 731 are uniformly angularly distributed. This has the advantage of centering the fork in the connecting-rod shank. Each blade has at least one end inserted into a notch 733 provided in the wall of the end cap 53. Each leaf spring has an independent and equal point spring effect on the toothing exerted by the blade pushing the tooth 731 into a recess in the toothing 331.

The force exerted by each tooth 731 on the notched ring 300 and therefore on the toothing 331 is then identical and predictable, which has the advantage of being able to size the desired force by increasing or decreasing the number of blades as for ball plungers.

In the case of two leaf springs with a single tooth for each leaf, the leaves are positioned so that they are symmetrical with respect to a plane passing through the longitudinal axis 5 of the connecting rod. The two teeth are therefore diametrically opposed and if only one end of each blade is inserted into a receptacle of the end cap, it is either the two ends located closest to the teeth or the two ends furthest from the teeth. This embodiment ensures, like the first embodiment, that the resisting torque does not depend on the direction of rotation of the connecting-rod shank relative to the fork.

According to an alternative embodiment of the second embodiment, the leaf spring has two teeth 731, and these are diametrically opposed as can be seen in FIG. 5.

Compared to a single leaf spring with two teeth, the effect of two ball plungers can be predicted and dimensioned more accurately because they exert forces independent of each other. Similarly, a leaf spring with multiple teeth will not have an equivalent reaction to an equivalent number of single-toothed leaf springs, each of which exerts an independent force, such as a ball plunger. Solutions with several ball plungers or several single-tooth leaf springs are therefore preferred to one multi-tooth leaf spring. In all embodiments of the invention, when there are several pressing elements, i.e., a plurality of ball plungers or leaf springs, they are independent of each other and are distributed around the circumference of the connecting-rod shank 50, and thus of the end cap 53, in an angularly uniform manner.

The rotation of the connecting-rod shank and therefore of the end cap 53 causes the leaf spring 730 to rotate. The spring effect of each blade exerts a force on tooth 731 and thus on the toothing 331 that increases as tooth 731 passes from a recess between two teeth of toothing 331 to the adjacent recess. This effort opposes a resistance to the rotational movement of the connecting-rod shank in relation to the fork by friction of the tooth 731 against the toothing, which means that the operator must exert a necessary and sufficient torque effort to rotate the connecting-rod shank in relation to the fork. This necessary and sufficient torque must be greater than the resisting torque of each tooth 731 on the toothing 331.

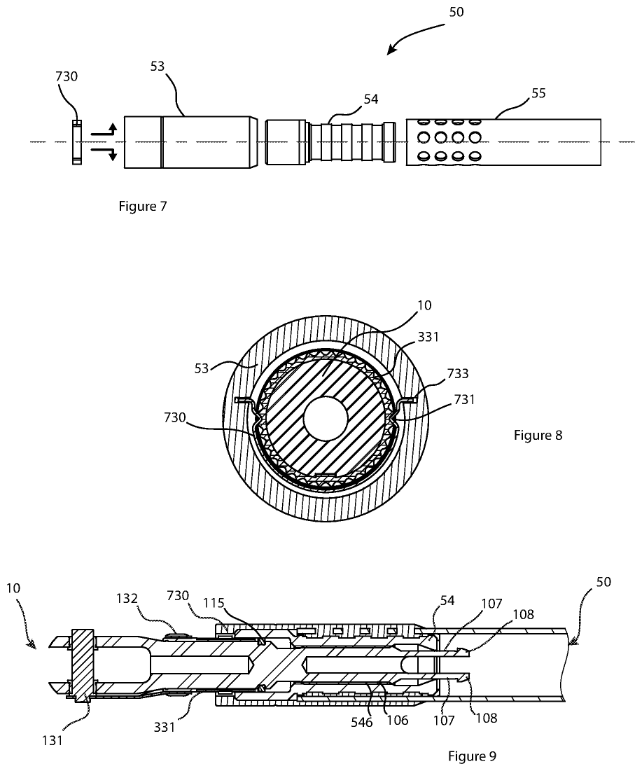

FIG. 9 illustrates a longitudinal section of one end of the connecting rod according to the second embodiment when the fork is in an intermediate position between the position where it is maximally extended with reference to FIG. 6b and the position where it is maximally retracted with reference to FIG. 6c.

Regardless of the embodiment of the invention, when no rotational torque is exerted on the connecting rod, the pressing elements exert a radial force on the bearing element perpendicular to the longitudinal axis 5 of the connecting rod. When a rotating torque is exerted on the connecting rod, the pressing element exerts a radial force and a tangential force on the bearing element, both forces being located in a transverse plane and perpendicular to the longitudinal axis 5 of the connecting rod.

The resultant of these two forces contributes to the resisting torque exerted on the connecting rod. As the angle between two teeth of toothing 331 decreases, the resisting torque increases. The angle between two teeth of the toothing 331 is between 60 and 120 degrees. The connecting rod according to the invention provides a resisting torque with preferably a defined value between 0.5 Nm and 10 Nm and preferably between 1 Nm and 3 Nm.

The resisting torque device guarantees the set length of the connecting rod by maintaining a minimum torque resistant to misalignment once the connecting rod has been installed and adjusted in length, even when installed on structures subject to vibration.

Since the load-bearing capacity of the connecting rod according to the invention can be increased by increasing the number of ball plungers or leaf springs, the connecting rod according to the invention can be adapted to more demanding structures without requiring many changes in its manufacturing method. In fact, a plurality of seats for ball plungers or leaf springs can be provided at the time of manufacturing of the end cap and be provided with the required number of plungers or blades to obtain a connecting rod with the desired torque resistance.

The torque exerted to set the connecting-rod shank in rotational motion is applied in the same transverse plane as the resisting torque exerted by the resisting torque device of the connecting rod according to the invention. This is achieved because the pressing element means for securing and the pressing element have a common plane of symmetry perpendicular to the longitudinal axis 5 of the connecting rod. This means that the receptacle 533 and 733 of each pressing element and the pressing element have a common plane of symmetry perpendicular to the longitudinal axis 5 of the connecting rod. The force exerted by the pressing element is also contained in this plane. In other words, the means for securing the pressing element to the end cap is not offset along the longitudinal axis with respect to the axis of the force it exerts.

On the other hand, in all positions of the fork in the connecting-rod shank, the surface in contact with the teeth of the toothing 331 is the same. The advantage of these features is that the torque required to vary the length of the connecting rod is constant regardless of the position of the fork in relation to the connecting-rod shank.

The preferred method of making and assembling a connecting rod according to the invention adapted for use on an aircraft comprises the following steps:

a) the connecting-rod shank 50 consisting of the end cap 53, the threaded insert 54 and the tube 55 is manufactured and assembled in a single injection-molding step,
b) the connecting element 10, 20 is machined in one piece, preferably from a metal material, with a first free end and a second end having a locking device 107, 108,
c) the notched ring 300 comprising the toothing 331 is integrally mounted on the connecting element,
d) the gasket 115 is placed in a groove 105 provided on the connecting element at the end of the notched ring,
e) at least one ball plunger 530 or leaf spring 730 is placed in the receptacle provided for this purpose in the wall thickness of the end cap,
f) the connecting element is inserted and screwed into the connecting-rod shank by cooperation of the threads and until the two blades 107 at the opposite end of the free end of the connecting element come to rest with their locking element in the form of a radially outwardly projecting bead 108 against the end of the threaded insert, the locking device thereby being automatically inserted.

According to a method of manufacturing and assembling the connecting rod according to the invention adapted for use on any type of structure, the toothing 331 is directly machined on the connecting element. The method comprises the following steps:

a) the connecting-rod shank 50 consisting of the end cap 53, the threaded insert 54 and the tube 55 is manufactured and assembled in a single injection-molding step,
b) the connecting element 10, 20 is machined in one piece, preferably from a metal material, with a first free end and a second end having a locking device 107, 108, and a central portion comprising the toothing 331,
c) the gasket 115 is placed in the groove 105 provided on the connecting element,
d) at least one ball plunger 530 or leaf spring 730 is placed in the receptacle provided for this purpose in the wall thickness of the end cap,
e) the connecting element is inserted and screwed into the connecting-rod shank by cooperation of the threads and until the two blades 107 at the opposite end of the free end of the connecting element come to rest with their locking element in the form of a radially outwardly projecting bead 108 against the end of the threaded insert, the locking device thereby being automatically inserted.

The manufacturing method of the connecting rod is such that once the connecting rod is assembled it is no longer possible to separate the fork from the connecting-rod shank, as the means of locking the fork in the connecting-rod shank are automatically put in place. The assembled connecting rod is a one-piece device. As a result, the two elements of the resistant torque device (including the bearing element attached to the fork and the pressing element attached to the connecting-rod shank) can no longer be disengaged from each other. The connecting rod cannot change length without the resisting torque device being activated.

The connecting rod according to the invention has the advantage of having a strong torque device that is active at all times and cannot be dismantled. Even in the event of incorrect assembly of the snap-in clip by the operator, the resistant torque is guaranteed by the connecting rod according to the invention, which is essential for use on aircraft. Since the snap-in clip has the sole function of connecting the connecting rod to its intended installation location, it does not apply any additional force to the rotational movement of the connecting-rod shank relative to the fork.

On the other hand, since the notch is not placed on the part of the connecting rod with the largest diameter, the connecting rod according to the invention reduces the risk of injury to the operator who handles and places the connecting rod.

1. A length-adjustable connecting rod having a longitudinal axis, comprising a connecting-rod shank provided with at least one internal thread, at least one connecting element comprising an external thread cooperating with the internal thread of the connecting-rod shank, the screwing or unscrewing of said connecting-rod shank with respect to said connecting element allowing the length of the connecting rod to be adjusted, and at least one resisting torque device between said connecting-rod shank and said connecting element, said resisting torque device comprising at least one pressing element and a bearing element, said pressing element exerting a force on said bearing element that opposes a resistance to the rotational movement of the connecting-rod shank with respect to said connecting element,
characterized in that the bearing element is integral with the connecting element and the pressing element is integral with the connecting-rod shank, and in that the force exerted by the pressing element on the bearing element is in a transverse direction and perpendicular to.

2. The connecting rod according to claim 1, wherein the connecting-rod shank comprises at least one means for securing the pressing element, said means for securing the pressing element and said pressing element having a common plane of symmetry perpendicular to the longitudinal axis of the connecting rod.

3. The connecting rod according to claim 1, wherein the connecting member is rotatably movable in the connecting-rod shank between two positions without being removable from the connecting-rod shank, means of locking being provided for locking said connecting member in said connecting-rod shank, said means of locking being automatically active upon assembly of the connecting rod.

4. The connecting rod according to claim 1, wherein the connecting element or comprises a free end provided with connecting means or, which extends into a central cylindrical portion that supports the toothing and a groove adapted to house a gasket therein.

5. The connecting rod according to claim 1, wherein the toothing forms part of a notched ring, said connecting member and said ring comprising means for securing the notched ring to the connecting member.

6. The connecting rod according to claim 5, wherein the central cylindrical part comprises on its external face on the side of the free end of the connecting element a circular flange located in a plane perpendicular to the longitudinal axis and at least one slot parallel to the axis, the external diameter of the said flange being 0.1 mm to 0.5 mm greater than the external diameter of the cylindrical part, said flange having two opposite faces, a flat face perpendicular to the axis situated on the side of the free end of the said connecting element and a truncated cone-shaped face directed towards the center of the connecting rod.

7. The connecting rod according to claim 6, wherein the internal diameter of the cylindrically shaped notched ring is equal to or slightly greater than the external diameter of the cylindrical part of the connecting element, said notched ring comprising on its cylindrical inner face an annular groove of complementary shape to that of the flange and at least one straight boss of complementary shape to that of the slot so that when the notched ring is slipped onto the connecting element, the groove of the notched ring cooperates with the flange and the boss of the notched ring cooperates with the slot in order to immobilize the notched ring on the connecting element.

8. The connecting rod according to claim 1, wherein said hollow connecting-rod shank is composed of a end cap, a threaded insert comprising the thread on its inner side and a tube, said threaded insert being attached to said tube by said end cap being made partly around said threaded insert, between said threaded insert and said tube and around said tube, by a thermoplastic injection process.

9. The connecting rod according to claim 2, wherein said pressing element comprises at least one ball plunger or at least one spring leaf, said means for securing said pressing element being a receptacle per ball plunger or at least one receptacle per spring leaf provided in the thickness of the wall of the connecting-rod shank, the shape of said receptacle being adapted to immobilize said push rod or said leaf against any translational movement in both directions of the longitudinal axis of the connecting rod.

10. The connecting rod according to claim 9, wherein in the case of a plurality of ball plungers or leaf springs, they are independent of each other and are distributed around the circumference of the connecting-rod shank in an angularly uniform manner.

11. The connecting rod according to claim 9, wherein said ball plunger comprises a spring that compresses a ball loosely mounted in said plunger, a portion of the surface of said ball flush with the outside of said plunger is in permanent contact with the toothing of the resisting torque device when the connecting element is assembled to the connecting-rod shank, said ball having a size adapted to cooperate with a recess of the toothing.

12. The connecting rod according to claim 9, wherein said leaf spring partially surrounds the toothing and at least one of its ends is inserted in a receptacle, said blade comprising at least one tooth (731) shaped to cooperate with a recess of the toothing (331), said tooth (731) being in permanent contact with the toothing of the resisting torque device when the connecting element is assembled to the connecting-rod shank.

13. The connecting rod according to claim 4, wherein said connecting member or is a fork, said connecting means of the fork being two ends each provided with an opening and said connecting means of the fork being two ends each provided with an opening said connecting rod comprising at least one fastener in the form of a snap-in clip comprising a pin intended to pass through the two openings or of the fork or via two rings, said pin being connected to a clip which snaps elastically around the cylindrical central part of the fork in order to couple the connecting rod to an external member without preventing the adjustment of its length.

14. A method of manufacturing a connecting rod according to claim 1, comprising the following steps:
a) the connecting-rod shank consisting of the end cap, the threaded insert and the tube is manufactured and assembled in a single injection-molding step,
b) the connecting element is machined in one piece, preferably from a metal material, with a first free end and a second end having a locking device,
c) the notched ring is integrally mounted on said connecting element,
d) the gasket is placed in a groove provided on the connecting element at the end of the notched ring,
e) at least one ball plunger or leaf spring is placed in the receptacle provided for this purpose in the wall thickness of the end cap,
f) said connecting element is inserted and screwed into said connecting-rod shank by cooperation of the threads and until the two blades at the opposite end of the free end of the connecting element come to rest with their locking element in the form of a radially outwardly projecting bead against the end of the threaded insert, the locking device thereby being automatically inserted.

15. A method of manufacturing a connecting rod according to claim 1, comprising the following steps:
a) the connecting-rod shank composed of the end cap, the threaded insert and the tube is manufactured and assembled in a single injection-molding step,
b) the connecting element is machined in one piece, preferably from a metal material, with a first free end and a second end having a locking device, and a central portion comprising the toothing,
c) the gasket is placed in the groove provided on the connecting element,
d) at least one ball plunger or leaf spring is placed in the receptacle provided for this purpose in the wall thickness of the end cap,
e) said connecting element is inserted and screwed into said connecting-rod shank by cooperation of the threads and until the two blades at the opposite end of the free end of the connecting element come to rest with their locking element in the form of a radially outwardly projecting bead against the end of the threaded insert, the locking device thereby being automatically inserted.
